(19) United States
(12) Patent Application Publication
(10) Pub. No.: US 2016/0148640 A1
(43) Pub. Date: May 26, 2016

(54) PERFORMANCE PACING FOR HARD DISK DRIVES

(71) Applicant: HGST NETHERLANDS B.V., Amsterdam (NL)

(72) Inventors: Raafat M. Zeid, San Jose, CA (US); David Frederick Glaess, West Linn, OR (US); Bernd Lamberts, Cupertino, CA (US); Hung M. Vu, Fremont, CA (US)

(21) Appl. No.: 14/554,529

(22) Filed: Nov. 26, 2014

(51) Int. Cl. G11B 19/28

(52) U.S. Cl. CPC G11B 19/28

(57) ABSTRACT

To provide enhanced operation of data storage devices and systems, various systems, apparatuses, methods, and software are provided herein. In a first example, a data storage device is provided. The data storage device includes one or more rotating storage media configured to rotate at a first rotation rate. The data storage device also includes a processing system configured to enter a performance pacing mode for the data storage device and alter performance of the data storage device based on at least a second rotation rate.

### TECHNICAL FIELD

Aspects of the disclosure are related to the field of data storage and hard disk drives in data storage systems.

### TECHNICAL BACKGROUND

Computer and network systems such as personal computers, workstations, server systems, and cloud storage systems, typically include data storage systems for storing and retrieving data. These data storage systems can include data storage devices, such as hard disk drives, solid state storage devices, tape storage devices, and other mass storage devices.

However, manufacturers of data storage devices typically manufacture different grades of data storage devices, such as enterprise and consumer grades, among others. These different grades of data storage drives can have different performance characteristics, such as throughput rates, transaction buffer sizes, rotation rates for rotating magnetic media, or latencies, among other characteristics. Many of these performance characteristics are fixed upon manufacture of a particular data storage device, such as due to design selection of various mechanical components to support a particular rotation rate (armatures, bearings, or lubricants) or of various solid state components to support a particular capacity or throughput (buffer chip types, memory capacities, or circuit board layouts).

### OVERVIEW

To provide enhanced operation of data storage devices and systems, various systems, apparatuses, methods, and software are provided herein. In a first example, a data storage device is provided. The data storage device includes one or more rotating storage media configured to rotate at a first rotation rate. The data storage device also includes a processing system configured to enter a performance pacing mode for the data storage device and alter performance of the data storage device based on at least a second rotation rate.

In another example, a method of operating a data storage device is presented. The method includes rotating one or more rotating storage media at a first rotation rate and entering a performance pacing mode for the data storage device and altering performance of the data storage device based on at least a second rotation rate.

In another example, a computer apparatus to operate a data storage device is presented. The computer apparatus includes processing instructions that direct the data storage device, when executed by the data storage device, to rotate one or more rotating storage media at a first rotation rate, and enter a performance pacing mode for the data storage device and alter the performance of the data storage device to emulate a second rotation rate. The computer apparatus also includes one or more non-transitory computer readable media that store the processing instructions.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a data system.

FIG. 2 is a flow diagram illustrating a method of operation of a data storage drive.

FIG. 3 is a system diagram illustrating a data system.

FIG. 4 is a flow diagram illustrating a method of operation of a data storage drive.

### DETAILED DESCRIPTION

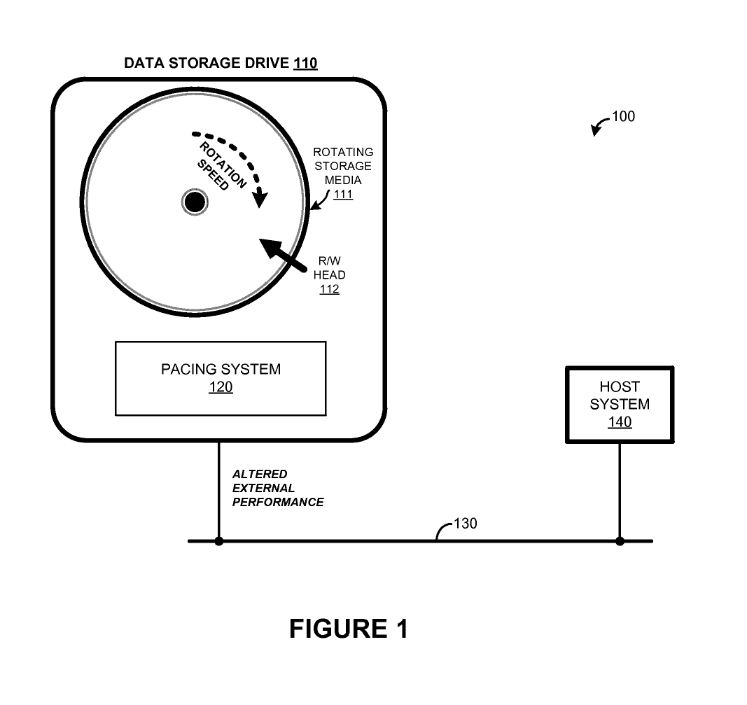

FIG. 1 is a system diagram illustrating data system 100. System 100 includes data storage device 110 and host system 140. Data storage device 110 and host system 140 communicate over storage interface 130. Data storage device 110 includes one or more rotating storage media 111, which can comprise platters of a hard disk drive in some examples. Data storage device 110 also includes pacing system 120. Pacing system 120 is configured to alter or modify performance of data storage drive 110. In addition, a data storage device can comprise a hybrid storage drive comprising one or more rotating storage media combined with solid-state storage media.

In operation, data storage device 110 receives read or write transactions over storage interface 130 issued by host system 140. Responsive to read transactions, data storage device 110 retrieves data stored upon media 111 with read/write (R/W) head 112 for transfer to host system 140. Responsive to write transactions, data storage device 110 stores data onto media 111 with R/W head 112. Rotating storage media 111 of data storage device 110 are rotated at a predetermined rate, which can be defined by a number of revolutions per minute (RPM). R/W head 112 is positioned over different areas of media 111 to read or write associated data. It should be understood that other components of data storage device 110 are omitted for clarity in FIG. 1, such as preamps, transceivers, processors, amplifiers, motors, servos, armatures, enclosures, and other electrical and mechanical elements.

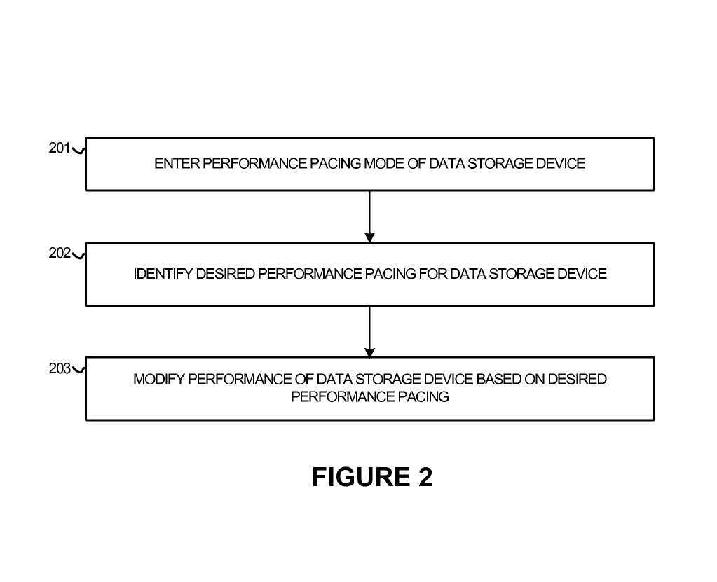

To further illustrate the operation of data system 100, FIG. 2 is provided. FIG. 2 is a flow diagram illustrating a method of operating data storage device 110. The operations of FIG. 2 are referenced below parenthetically. In FIG. 2, pacing system 120 enters (201) a performance pacing mode of data storage device 110. The performance pacing mode can be entered responsive to a command received over storage interface 130 from host 140 or other systems. The performance pacing mode can be entered responsive to a command received over a maintenance interface from manufacturing configuration or testing systems. The performance pacing mode can be entered as a default performance mode of data storage device 110 upon power up.

Pacing system 120 identifies (202) desired performance pacing for data storage device 110. The desired performance pacing can include reducing performance of data storage device 110. For example, rotating storage media 111 might rotate at a first rotation rate and a desired performance might include performance associated with second rotation rate. However, in this example, the rotation rate of rotating storage media 111 is not modified by pacing system 120.

Pacing system 120 modifies (203) performance of data storage drive 110 based on the desired performance pacing. As mentioned above, the rotation rate of rotating storage media 111 is not modified or altered, possibly due to being fixed due to the manufacturing components or mechanical design of data storage device 110. Pacing system 120 can throttle performance of data storage device 110 while data storage device 110 maintains a rotation rate. For example, pacing system 120 can emulate performance of a second, slower, rotation rate while rotating storage media 111 maintains a first rotation rate. This performance emulation can include modifying characteristics of data storage drive 110, such as seek delays, latencies, track skew, or other performance characteristics of data storage drive 110. Thus, to an external system, such as host system 140, data storage device 110 appears to perform as if the rotating storage media were rotating at a different rate.

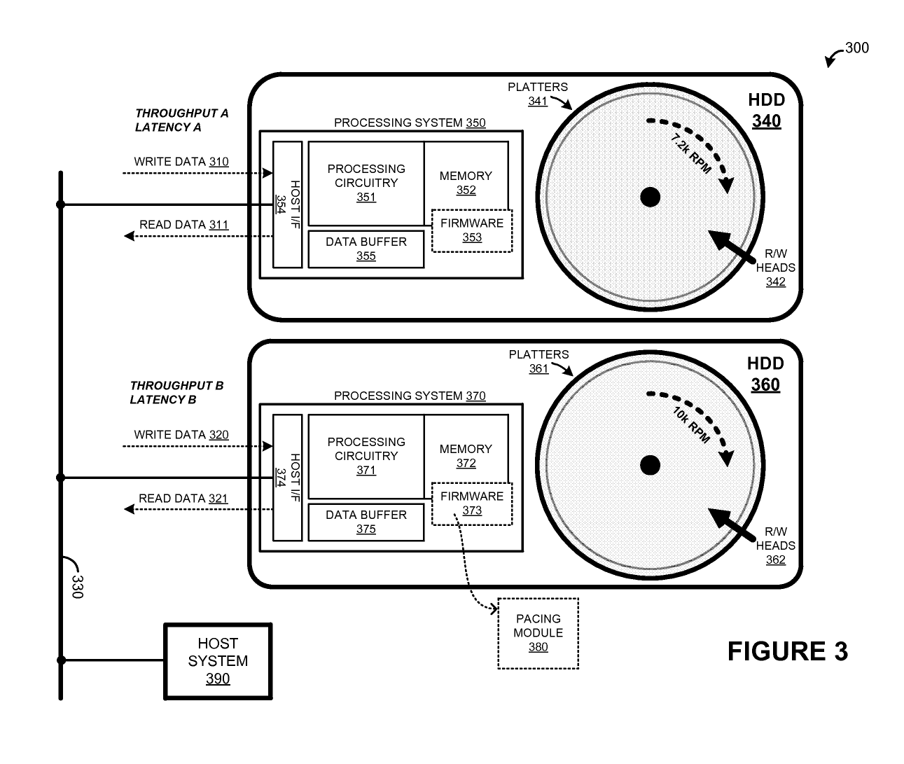

As a further example data storage system employing a data storage drive, FIG. 3 is presented. FIG. 3 is a system diagram illustrating data storage system 300.

Data storage system 300 includes two hard disk drives, namely HDD 340 and HDD 360. These two hard disk drives communicate over storage link 330 with at least host system 390.

Storage link 330 can include one or more links, although a combined link is sown in FIG. 3. Storage link 330 can comprise any storage or disk interface, such as Serial Attached ATA (SATA), Serial Attached SCSI (SAS), FibreChannel, Universal Serial Bus (USB), SCSI, InfiniBand, Peripheral Component Interconnect Express (PCIe), Ethernet, Internet Protocol (IP), or other parallel or serial storage or peripheral interfaces, including variations and combinations thereof.

Host system 390 can include one or more computing and network systems, such as personal computers, servers, cloud storage systems, packet networks, management systems, or other computer and network systems, including combinations and variations thereof. In operation, host system 390 issues read and write commands to any of HDD 340 and 360 over storage link 330. In further examples, host system 390 can issue one or more commands to enter HDD 360 to enter into a performance pacing mode.

HDD 340 and HDD 360 each include similar electrical components, such as host interfaces, processing circuitry, data buffers, memory, and read/write heads. However, in this example HDD 340 includes platters 341 which are rotated or spun at a first rotation rate, namely 7200 RPM. HDD 360 includes platters 361 which are rotated or spun at a second rotation rate, namely 10000 RPM. Each respective HDD includes mechanical components that are tailored to the specific rotation rate, and the specific rotation rate is typically fixed as per design and manufacturing. Specifically, motors, air bearings, armature properties, read channel properties, and platter balancing characteristics, among other components and properties, are selected based on the respective rotation rate of each HDD. Thus, HDD 340 cannot be rotated at 10000 RPM without damage or severe performance problems, and likewise HDD 360 cannot be rotated at 7200 PRM without damage or severe performance problems. It should be understood that other components of HDD 340 and HDD 360 are omitted for clarity in FIG. 3, such as preamps, transceivers, processors, amplifiers, motors, servos, armatures, enclosures, and other electrical and mechanical elements.

HDD 340 includes processing system 350 which further includes processing circuitry 351, memory 352, host interface 354, and buffer 355. Memory 352 also includes firmware 353 which is executed by at least processing circuitry 351 of processing system 350 to operate HDD 340 at 7200 RPM and respond to read and write commands received over storage link 330.

HDD 360 includes processing system 370 which further includes processing circuitry 371, memory 372, host interface 374, and buffer 375. Memory 372 also includes firmware 373 which is executed by at least processing circuitry 371 of processing system 370 to operate HDD 360 at 10000 RPM and respond to read and write commands received over storage link 330. Furthermore, firmware 373 includes pacing module 380 which, when executed by at least processing circuitry 371, allows for pacing of the performance of HDD 360 to emulate performance of a 7200 RPM hard disk drive even though platters 361 of HDD 360 are rotated at a 10000 RPM rate.

Host interface 374 includes one or more storage interfaces for communicating with host systems, networks, and the like. Host interface 374 can comprise transceivers, interface circuitry, connectors, buffers, microcontrollers, and other interface equipment.

Buffer 375 includes one or more non-transitory computer readable memory elements. Buffer 375 can include RAM, SRAM, flash memory, magnetic RAM, phase change memory, among other memory technologies. Buffer 375 is employed as a temporary storage location for operations received over host interface 374. Buffer 375 stores one or more Input/Output Operations (IOPs) for handling by HDD 360. For example, buffer 375 can be configured to have a variable depth from 1 IOP to 64 IOPs (among other depths) which can be used to store read or write commands received over link 330 for processing by processing system 370. Buffer 375 can be included in elements of host interface 374, processing circuitry 371, or memory 372. In some examples, buffer 375 is included in separate elements.

Processing system 370 also includes processing circuitry 371 and memory 372. Processing circuitry 371 can comprise one or more microprocessors and other circuitry that retrieves and executes firmware 373 from memory 372. Processing circuitry 371 can be implemented within a single processing device but can also be distributed across multiple processing devices or sub-systems that cooperate in executing program instructions. Examples of processing circuitry 371 include general purpose central processing units, application specific processors, and logic devices, as well as any other type of processing device, combinations, or variations thereof.

Memory 372 can comprise any non-transitory computer readable storage media readable by processing circuitry 371 and capable of storing firmware 373. Memory 372 can include volatile and nonvolatile, removable and non-removable media implemented in any method or technology for storage of information, such as computer readable instructions, data structures, program modules, or other data. In addition to storage media, in some implementations memory 372 can also include communication media over which firmware 373 can be communicated. Memory 372 can be implemented as a single storage device but can also be implemented across multiple storage devices or sub-systems co-located or distributed relative to each other. Memory 372 can comprise additional elements, such as a controller, capable of communicating with processing circuitry 371. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that can be accessed by an instruction execution system, as well as any combination or variation thereof, or any other type of storage media.

Firmware 373 and pacing module 380 can be implemented in program instructions and among other functions can, when executed by HDD 360 in general or processing circuitry 371 in particular, direct HDD 360 or processing circuitry 371 to operate as described herein. Firmware 373 and pacing module 380 can include additional processes, programs, or components, such as operating system software, database software, or application software. Firmware 373 and pacing module 380 can also comprise software or some other form of machine-readable processing instructions executable by processing circuitry 371. In at least one implementation, the program instructions can include first program instructions that direct processing system 370 to rotate one or more platters 361 at a first rotation rate, enter a performance pacing mode for HDD 360 and alter the performance of HDD 360 to emulate a second rotation rate, among other operations.

In general, firmware 373 and pacing module 380 can, when loaded into processing circuitry 371 and executed, transform processing circuitry 371 overall from a general-purpose computing system into a special-purpose computing system customized to operate as described herein. Encoding firmware 373 and pacing module 380 on memory 372 can transform the physical structure of memory 372. The specific transformation of the physical structure can depend on various factors in different implementations of this description. Examples of such factors can include, but are not limited to the technology used to implement the storage media of memory 372 and whether the computer-storage media are characterized as primary or secondary storage. For example, if the computer-storage media are implemented as semiconductor-based memory, firmware 373 and pacing module 380 can transform the physical state of the semiconductor memory when the program is encoded therein. For example, firmware 373 and pacing module 380 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

The various elements of processing system 350 of HDD 340 can include similar elements as discussed above for processing system 370 of HDD 360. However, as discussed above, platters of each of HDD 340 and HDD 360 rotate at different rates and HDD 360 also includes firmware 373 and pacing module 380. Various other components can vary between HDD 340 and HDD 360, which can include variation in the selected elements of processing systems 350 and 370, platters 341 and 361, and R/W heads 342 and 362, among other components.

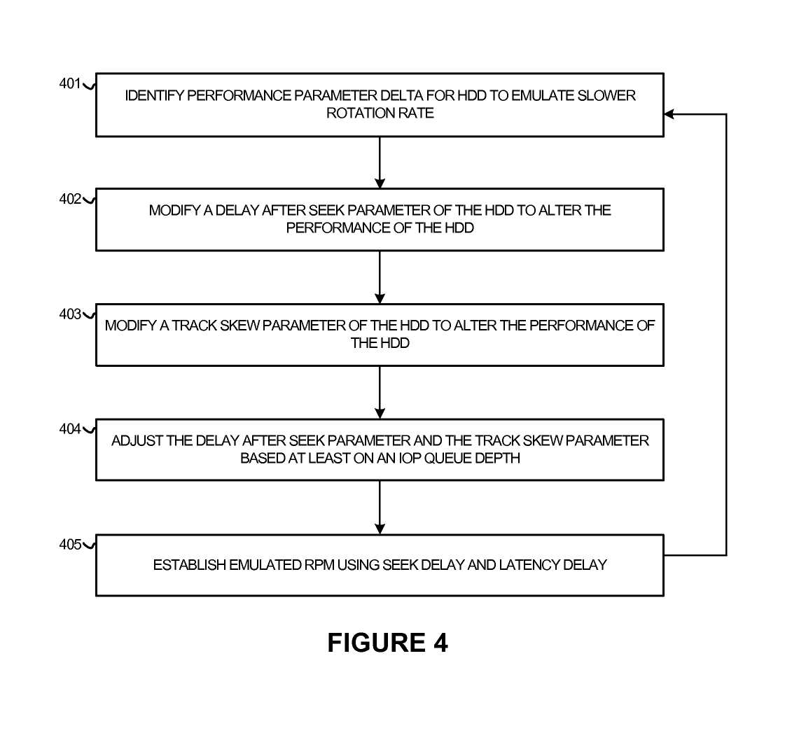

To further illustrate the operation of system 300 and HDD 360, FIG. 4 is presented. FIG. 4 is a flow diagram illustrating a method of operation of HDD 360. The operations of FIG. 4 are referenced below parenthetically. In FIG. 4, processing system 370 identifies (401) performance parameter delta for HDD 360 to a emulate slower rotation rate. In some examples, the identification of the performance parameter delta can be performed by systems external to HDD 360, such as computing systems, manufacturing characterization systems, and the like, and performance delta information can be stored in HDD 360, such as in a data structure maintained by pacing module 380 in memory 372.

Identifying the performance delta can include characterizing seek delays or establishing a seek delay curve for normal 10000 RPM performance of HDD 360. These seek delays can include the delay between command receipt or execution time and seek length for HDD 360 when not in a performance pacing mode. A seek time for a HDD includes a time involved with repositioning a R/W head of HDD 360 to handle a particular read or write. For example, R/W head 362 can be positioned at a first location on platters 361 from a first read or write, and when a second read or write arrives, R/W head 362 must be repositioned to a different location on platters 361 to handle the second read or write. This seek time can vary based on rotation rate of the platters, among other factors. In a 10000 RPM HDD, such as HDD 360, the seek time can be characterized. A delta time curve can be identified based on the seek times of HDD 360 to pace or detune the performance of HDD 360 to emulate a slower rotation rate, such as a 7200 RPM rate.

Identifying the performance delta can also include creating a latency delay function that uses RPM and queue depth of data buffer 355 as inputs. The RPM can be a target RPM which is slower than the native RPM of HDD 360. For example, if the native RPM of HDD 360 is 10000 RPM, then the target RPM can be a slower RPM, such as 7200 RPM or 5400 RPM, among others. As a queue depth varies, such as an IOP queue depth provided by buffer 375, performance of HDD 360 can vary. This performance variation can be due to optimization and reordering of read/write commands by processing circuitry 371 to handle storage transactions in a different order than received over link 330. Each queue depth can have a corresponding performance characterized for HDD 360 while operating in a non-paced native mode. A latency delay for each queue depth, such as a queue depth from 1 to 64 IOPs can be characterized for HDD 360. The latency delay can include a time delay from the receipt of a storage transaction (read/write) and execution of the storage transaction (commit of write data to platters 361 or read of data from platters 361).

Processing system 370 modifies (402) a delay after seek parameter of HDD 360 to alter the performance of HDD 360. Based on at least the seek delay curve characterized in operation 401, a delay after seek parameter of HDD 360 can be modified to alter the performance of HDD 360 to emulate a target rotation rate. A delay after seek includes a time delay introduced after R/W heads 362 have moved to a correct position over platters 361. This time delay can include a settle time which allows R/W heads 362 to stop moving and vibrating due to repositioning so R/W heads 362 do not read off from a desired track on platters 361. Additional delay can be introduced into this settle time to reduce performance of HDD 360. This additional delay can be introduced into the timeframe after R/W heads 362 have been repositioned by before R/W heads 362 actually begin reading data from or writing data to platters 361.

Processing system 370 modifies (403) a track skew parameter of HDD 360 to alter the performance of HDD 360. Track skew is a track-to-track offset between the beginning storage area of each track. Each track includes a first logical block address (LBA) for storing and retrieving data on that track. Adjacent tracks on a particular platter have an offset for this first LBA so that when streaming data to or from a platter a R/W head can reposition to an adjacent track and resume a read or write without having to wait for an entire rotation of the platter. In this example, a track skew of platters 361 is adjusted to modify performance of HDD 360 to emulate the target rotation rate. Track skew can affect a throughput, such as a megabytes per second (MB/s) throughput of HDD 360.

Processing system 370 adjusts (404) the delay after seek parameter and the track skew parameter based at least on a queue depth. As discussed above, a queue depth, such as an IOP queue depth, can vary. This variation can affect the performance of HDD 360 and alters how each of the delay after seek parameter and track skew parameter affect the performance pacing of HDD 360 to emulate the target rotation rate. Processing system 370 adjusts these parameters based on at least the queue depth presently employed. The queue depth can vary during operation of HDD 360 or can be set by an external system, such as a user or host system 390. Processing system 370 monitors the present queue depth and adjusts the delay after seek parameter and the track skew parameter based at least on a queue depth. This adjustment can be done once per power cycle of HDD 360, fixed if an unchanging queue depth is employed, or changed during operation of HDD 360 if a variable queue is employed. The queue depth might be varied from 1 IOP to 64 IOPs, and processing system 370 can adjust the delay after seek parameter and the track skew parameter based on this depth to maintain emulation of the target rotation rate.

Processing system 370 then establishes (405) emulated RPM using the seek delay and latency delay discussed above. This emulated RPM differs from the native RPM of HDD 360 and allows for external systems, such as host system 390 to interact with HDD 360 as if it was a different speed HDD. For example, HDD 360 is shown as having a native 10000 RPM rotation rate in FIG. 3, while HDD 340 is shown as having a native 7200 RPM rotation rate. HDD 360 can emulate performance of HDD 340 without changing the rotation rate of platters 360 from 10000 RPM. HDD can emulate a 7200 RPM rotation rate by at least varying the seek delay and latency delay discussed above. For example, the delay after seek and track skew parameters can be varied according to a present queue depth to match performance of a slower rotating HDD platter.

In addition to emulating performance of a slower HDD platter, HDD 360 can also present characteristics and device information to external devices over link 330 as if it were employing platters rotating at the slower rate. For example, HDD 360 can respond to informational queries about HDD by reporting a different rotation rate, throughput rate, latency, among other parameters to a host system. A different model number can be reported to an external system that indicates a slower rotation rate than platters 361 actually rotate. For example, platters 361 can rotate at 10000 RPM but HDD 360 can report to external systems that platters 361 rotate at 7200 RPM. Moreover, the performance of HDD 360 is modified to emulate that of a 7200 RPM hard disk drive, such as HDD 340, as discussed above. In this manner, performance of HDD 360 is detuned to emulate the performance of a hard disk drive with a slower rotation rate.

In further examples, HDD 360 can be locked upon manufacture to emulate a particular rotation rate, such as the detuned target rotation rate. This lock can include a firmware flag or setting in pacing module 380 which prevents external modification of the performance pacing by a customer or external system. The performance pacing mode can be entered upon power up of HDD 360 and HDD 360 remains in the performance pacing mode during operation to emulate the slower rotation rate. A capacity of HDD 360 can also be modified to present a different capacity of HDD 360 while in the performance pacing mode. This different capacity can be used to differentiate HDD 360 while operating in the performance pacing mode and when HDD 360 is operating in a native performance mode.

Once HDD 360 is in the performance pacing mode, such as to emulate or detune to the performance commensurate with a slower rotation, then platters 361 continue to rotate at the native rotation rate, such as 10000 RPM in FIG. 3. Externally observable throughput ‘B’ and latency ‘B’ of FIG. 3 can be matched to that of a slower hard disk drive, such as throughput ‘A’ and latency ‘A’ of HDD 340. When write data 320 is written to platters 361 or when read data 321 is read from platters 362, a slower throughput and longer latency is emulated by HDD 360. This slower throughput and longer latency emulated by HDD 360 can be adjusted to emulate performance of HDD 340.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A data storage device configured to store and retrieve data, the data storage device comprising:
one or more rotating storage media configured to rotate at a first rotation rate;
a processing system configured to enter a performance pacing mode for the data storage device and alter performance of the data storage device based on at least a second rotation rate.

2. The data storage device of claim 1, comprising:
the processing system configured to alter the performance of the data storage device to emulate the second rotation rate.

3. The data storage device of claim 1, comprising:
the processing system configured to alter performance provided over a storage interface of the data storage device to emulate the second rotation rate while maintaining the first rotation rate for the one or more rotating storage media.

4. The data storage device of claim 1, comprising:
the processing system configured to modify a delay after seek parameter of the data storage device to alter the performance of the data storage device.

5. The data storage device of claim 1, comprising:
the processing system configured to modify a track skew parameter of the data storage device to alter the performance of the data storage device.

6. The data storage device of claim 1, comprising:
the processing system configured to identify an Input/Output Operation (IOP) queue depth for the data storage device and determine a delay after seek parameter and a track skew parameter based at least on the IOP queue depth and the second rotation rate; and
the processing system configured to emulate the second rotation rate for the data storage device based at least on the delay after seek parameter and the track skew parameter.

7. The data storage device of claim 6, comprising:
the processing system configured to alter the performance of the data storage device to emulate the second rotation rate across a variable IOP queue depth.

8. The data storage device of claim 1, wherein the first rotation rate comprises a 10,000 revolutions per minute (RPM) rotation rate, wherein the second rotation rate comprises a 7,200 RPM rotation rate, and wherein the one or more rotating storage media rotates at the first rotation rate when the data storage device is in the performance pacing mode; and
the processing system configured to alter the performance of the data storage device to emulate the 7,200 RPM rotation rate over an external interface of the data storage device when the data storage device is in the performance pacing mode.

9. A method of operating a data storage device to store and retrieve data, the method comprising:
rotating one or more rotating storage media at a first rotation rate;
entering a performance pacing mode for the data storage device and altering performance of the data storage device based on at least a second rotation rate.

10. The method of claim 9, comprising:
altering the performance of the data storage device to emulate the second rotation rate.

11. The method of claim 9, further comprising:
altering performance provided over a storage interface of the data storage device to emulate the second rotation rate while maintaining the first rotation rate for the one or more rotating storage media.

12. The method of claim 9, comprising:
modifying a delay after seek parameter of the data storage device to alter the performance of the data storage device.

13. The method of claim 9, comprising:
modifying a track skew parameter of the data storage device to alter the performance of the data storage device.

14. The method of claim 9, further comprising:
identifying an Input/Output Operation (IOP) queue depth for the data storage device and determining a delay after seek parameter and a track skew parameter based at least on the IOP queue depth and the second rotation rate; and
emulating the second rotation rate for the data storage device based at least on the delay after seek parameter and the track skew parameter.

15. The method of claim 14, further comprising:
altering the performance of the data storage device to emulate the second rotation rate across a variable IOP queue depth.

16. The method of claim 9, wherein the first rotation rate comprises a 10,000 revolutions per minute (RPM) rotation rate, wherein the second rotation rate comprises a 7,200 RPM rotation rate, and wherein the one or more rotating storage media rotates at the first rotation rate when the data storage device is in the performance pacing mode; and further comprising:
altering the performance of the data storage device to emulate the 7,200 RPM rotation rate over an external interface of the data storage device when the data storage device is in the performance pacing mode.

17. A computer apparatus to operate a data storage device configured to store and retrieve data, the computer apparatus comprising:
processing instructions that direct the data storage device, when executed by the data storage device, to:
rotate one or more rotating storage media at a first rotation rate;
enter a performance pacing mode for the data storage device and alter the performance of the data storage device to emulate a second rotation rate; and
one or more non-transitory computer readable media that store the processing instructions.

18. The computer apparatus of claim 17, comprising further processing instructions that direct the data storage device, when executed by the data storage device, to:
modify a delay after seek parameter of the data storage device and modify a track skew parameter of the data storage device to alter the performance of the data storage device to emulate the second rotation rate.

19. The computer apparatus of claim 18, comprising further processing instructions that direct the data storage device, when executed by the data storage device, to:
identify an Input/Output Operation (IOP) queue depth for the data storage device and determine a delay after seek parameter and a track skew parameter based at least on the IOP queue depth and the second rotation rate; and
emulate the second rotation rate for the data storage device based at least on the delay after seek parameter and the track skew parameter.

20. The computer apparatus of claim 17, wherein the first rotation rate comprises a 10,000 revolutions per minute (RPM) rotation rate, wherein the second rotation rate comprises a 7,200 RPM rotation rate, and wherein the one or more rotating storage media rotates at the first rotation rate when the data storage device is in the performance pacing mode; and comprising further processing instructions that direct the data storage device, when executed by the data storage device, to:
alter the performance of the data storage device to emulate the 7,200 RPM rotation rate over an external interface of the data storage device when the data storage device is in the performance pacing mode.
